(19) United States
(12) Patent Application Publication
(10) Pub. No.: US 2012/0017828 A1
(43) Pub. Date: Jan. 26, 2012

(54) APPARATUS FOR MANUFACTURING TRANSPARENT CONDUCTIVE LAYER

(75) Inventors: Youn Soo Kim, Seoul (KR); Yong Hyun Jin, Seoul (KR); Jong Young Lee, Gyunggi-do (KR); Ji Soo Lee, Gyunggi-do (KR); Sang Hwa Kim, Gyunggi-do (KR)

(73) Assignee: SAMSUNG ELECTRO-MECHANICS CO., LTD., Gyunggi-do (KR)

(21) Appl. No.: 13/183,546

(22) Filed: Jul. 15, 2011

(30) Foreign Application Priority Data
Jul. 20, 2010 (KR) 1020100070069

(51) Int. Cl. B05B 5/10; B05B 5/00

(52) U.S. Cl. 118/620

(57) ABSTRACT

Disclosed herein is an apparatus for manufacturing a transparent conductive layer. The apparatus includes a transparent substrate, a longitudinal direction of which is arranged in an X axis direction. Jetting means jets a conductive polymer solution, containing ions, onto a first surface of the transparent substrate in a Y axis direction. A wire is spaced apart from a second surface of the transparent substrate by a predetermined distance and arranged in a Z axis direction. Voltage application means generates electric attractive force between the wire and the conductive polymer solution by applying a potential having polarity opposite to that of the ions to the wire. The apparatus adds ions to the conductive polymer solution, and employs a wire to which a potential having polarity opposite to that of the ions is applied, thus obtaining the advantage that the target substrate can be uniformly coated with the conductive polymer solution.

### CROSS REFERENCE TO RELATED APPLICATION

This application claims the benefit of Korean Patent Application No. 10-2010-0070069, filed on Jul. 20, 2010, entitled “Apparatus for manufacturing transparent conductive layer”, which is hereby incorporated by reference in its entirety into this application.

### BACKGROUND OF THE INVENTION

1. Technical Field

The present invention relates to an apparatus for manufacturing a transparent conductive layer.

2. Description of the Related Art

Auxiliary devices for computers have developed alongside the development of computers using digital technology. Personal computers, portable transmission devices, other private information processing devices, etc. perform text and graphic processing using various types of input devices such as a keyboard and a mouse.

However, with the rapid progress of an information-oriented society, the trend is for the use of computers is to gradually expand. Therefore, there is a problem in that it is difficult to efficiently drive products with just a keyboard and a mouse which function as current input devices. Therefore, there is an increased necessity for devices which not only have a simple structure and low erroneous manipulation, but which also enable anyone to easily input information.

Further, technology for input devices is exceeding just the current level which satisfies typical functions, and an interest in the typical functions has changed to an interest in high reliability, durability, innovation, design, processing-related technology, etc. In order to satisfy this interest, a touch panel has been developed as an input device enabling information such as text and graphic information to be input.

Such a touch panel is a tool which is installed on the display surface of an image display device such as an electronic scheduler, a Flat Panel Display (FPD), for example, a Liquid Crystal Display (LCD) device, a Plasma Display Panel (PDP), and an electroluminescence device, and a Cathode Ray Tube (CRT), and which is used to allow a user to select desired information while viewing the image display device.

Touch panels are classified into a resistive type, a capacitive type, an electro-magnetic type, a Surface Acoustic Wave (SAW) type, and an infrared type. Various types of touch panels are employed in electronic products in consideration of the problems of signal amplification, differences in resolution, the degree of difficulty in design and processing technology, optical characteristics, electrical characteristics, mechanical characteristics, environment resistant characteristics, input characteristics, durability, and economic efficiency.

Meanwhile, in order to manufacture a touch panel, a transparent conductive layer which is transparent and has high electric conductivity with respect to visible rays is required. Such a transparent conductive layer is manufactured by depositing an Indium Tin Oxide (ITO) having excellent electric conduction characteristics on a glass or plastic substrate.

When the ITO is deposited on the substrate, sputtering is typically used. The term ‘sputtering’ refers to a kind of physical thin film formation process, which is a method of forming vapor particles using a physical method and depositing an ITO on a substrate. In other words, ion particles having high kinetic energy collide with a target material which is an ITO composite, so that the target material is discharged, and the discharged target material is attached to the substrate, thus completing the deposition of the ITO. When the ITO is deposited on the substrate using sputtering, a film having excellent electric conductivity and visible ray transmittance can be manufactured. However, there are problems because a sputter for performing sputtering is very expensive, and the size of the substrate is limited to that of the sputter, thus making it difficult to manufacture a large-area touch panel.

Further, the above-described ITO basically has excellent electric conductivity, but when a substrate is bent under an external force, the electric conductivity changes, thereby deteriorating the sensitivity of a touch panel. Furthermore, in the ITO, visible ray transmittance changes relatively largely according to variations in the wavelength. Therefore, there is a problem in that the visibility of a touch panel is deteriorated because visible ray transmittance is greatly decreased at specific wavelengths.

### SUMMARY OF THE INVENTION

Accordingly, the present invention has been made keeping in mind the above problems occurring in the prior art, and the present invention is intended to provide an apparatus for manufacturing a transparent conductive layer, which adds ions to a conductive polymer solution, and employs a wire to which a potential having the polarity opposite to that of the icons is applied, thus enabling a transparent substrate to be uniformly coated with the conductive polymer solution.

In accordance with an aspect of the present invention, there is provided an apparatus for manufacturing a transparent conductive layer, comprising a transparent substrate, a longitudinal direction of which is arranged in an X axis direction, jetting means configured to jet a conductive polymer solution, containing ions, onto a first surface of the transparent substrate in a Y axis direction, a wire spaced apart from a second surface of the transparent substrate by a predetermined distance and arranged in a Z axis direction, and voltage application means configured to generate an electric attractive force between the wire and the conductive polymer solution by applying a potential having a polarity opposite to that of the ions to the wire.

In an embodiment, the conductive polymer solution comprises poly-3, 4-ethylenedioxythiophene/poly styrenesulfonate (PEDOT/PSS), polyaniline, polyacetylene, or polyphenylene vinylene.

In an embodiment, the ions are positive ions of alkali metals or positive ions of alkaline earth metals.

In an embodiment, the positive ions of alkali metals are Na⁺ or K⁺ ions.

In an embodiment, the positive ions of alkaline earth metals are Mg²⁺ or Ca²⁺ ions.

In an embodiment, the voltage application means applies a negative potential to the wire.

In an embodiment, the apparatus further comprises moving means for moving the transparent substrate in the X axis direction.

In an embodiment, the apparatus further comprises driving means for driving the jetting means in the X axis or Z axis direction so that the jetting means jets the conductive polymer solution onto the first surface of the transparent substrate to form patterns on the transparent substrate.

### BRIEF DESCRIPTION OF THE DRAWINGS

FIGS. 1 and 2 are diagrams showing a manufacturing process performed by an apparatus for manufacturing a transparent conductive layer according to an embodiment of the present invention.

### DESCRIPTION OF THE PREFERRED EMBODIMENTS

Prior to giving the description, the terms and words used in the present specification and claims should not be interpreted as being limited to their typical meaning based on the dictionary definitions thereof, but should be interpreted to have the meaning and concept relevant to the technical spirit of the present invention on the basis of the principle by which the inventor can suitably define the implications of terms in the way which best describes the invention.

The above and other objects, features and advantages of the present invention will be more clearly understood from the following detailed description taken in conjunction with the accompanying drawings. In the present specification, reference now should be made to the drawings, in which the same reference numerals are used throughout the different drawings to designate the same or similar components. Further, the terms “X axis direction”, “Y axis direction” and “Z axis direction” are used to indicate a structural relationship among components, and components of the present invention are not limited by those terms. Further, in the description of the present invention, if detailed descriptions of related well-known constructions or functions are determined to make the gist of the present invention unclear, the detailed descriptions will be omitted.

Hereinafter, embodiments of the present invention will be described in detail with reference to the attached drawings.

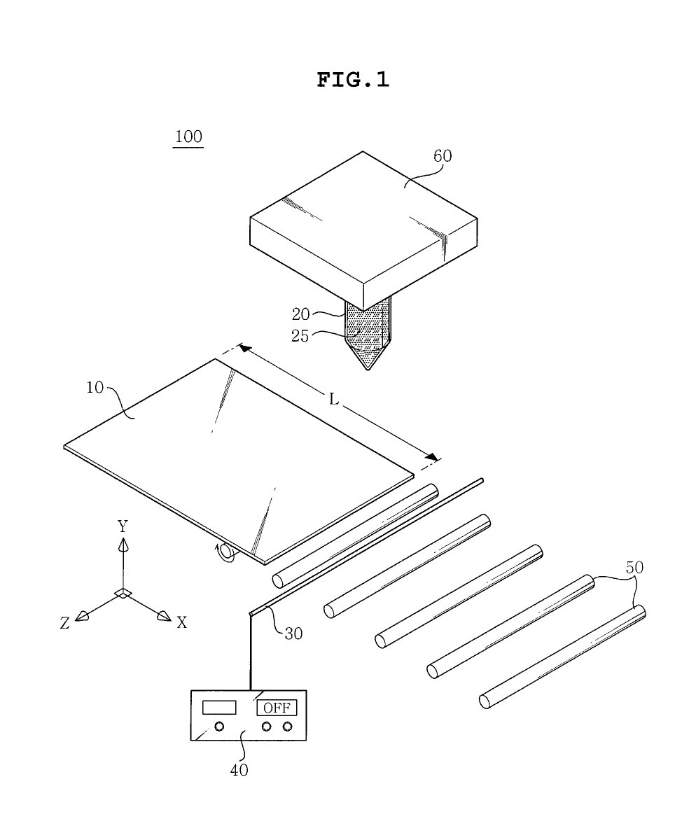

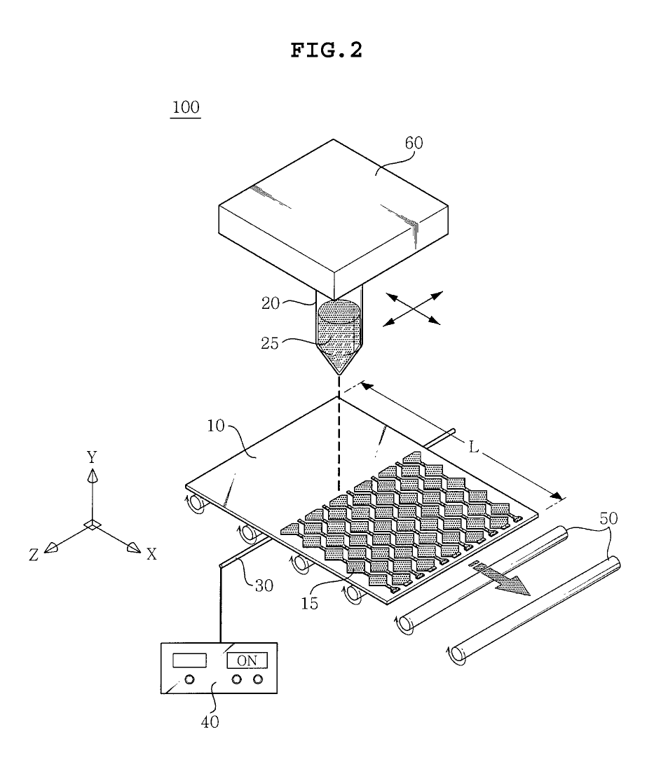

FIGS. 1 and 2 are diagrams showing a manufacturing process performed by an apparatus for manufacturing a transparent conductive layer according to an embodiment of the present invention.

As shown in FIGS. 1 and 2, an apparatus 100 for manufacturing a transparent conductive layer according to the present embodiment includes a transparent substrate 10, a jetting means 20, a wire 30, and a voltage application means 40. The longitudinal direction L of the transparent substrate 10 is arranged in an X axis direction. The jetting means 20 jets a conductive polymer solution 25, containing ions, onto one surface of the transparent substrate 10 in a Y axis direction. The wire 30 is spaced apart from the other surface of the transparent substrate 10 by a predetermined distance and is arranged in a Z axis direction. The voltage application means 40 is configured to generate an electric attractive force between the wire 30 and the conductive polymer solution 25 by applying a potential having the polarity opposite to that of the ions to the wire 30.

The transparent substrate 10 is configured to provide a plane onto which the conductive polymer solution 25 is jetted and which will be coated with the conductive polymer solution 25. The longitudinal direction L of the transparent substrate 10 is arranged in the X axis direction. Further, the transparent substrate 10 is moved in the X axis direction by a moving means 50 such as a roller so as to perform a continuous manufacturing process. Here, the transparent substrate 10 may be preferably made of a material such as polyethylene terephthalate (PET), poly carbonate (PC), polymethyl methacrylate (PMMA), polyethylene naphthalate (PEN), polyethersulfone (PES), Cyclic Olefin Copolymer (COC), a triacetylcellulose (TAC) film, a polyvinyl alcohol (PVA) film, a polyimide (PI) film, polystyrene (PS), biaxially oriented PS (K resin containing BOPS), glass, tempered glass, etc. However, the material of the transparent substrate 10 is not necessarily limited to those examples. Meanwhile, it is preferable to activate one surface of the transparent substrate 10 by performing high-frequency processing or primer processing thereon, that is, onto the surface of the transparent substrate 10 onto which the conductive polymer solution 25 will be jetted. The adhesive strength between the transparent substrate 10 and the conductive polymer solution 25 can be improved by activating one surface of the transparent substrate 10.

The jetting means 20 functions to jet the conductive polymer solution 25 and is configured such that the jet orifice thereof is arranged to face one surface of the transparent substrate 10 to jet the conductive polymer solution 25 in the Y axis direction. Meanwhile, a driving means 60 for driving the jetting means 20 may be provided. The driving means 60 allows the jetting means 20 to form patterns on one surface of the transparent substrate 10 with the conductive polymer solution 25. Therefore, the driving means 60 drives the jetting means 20 in the X axis or Z axis direction. In the drawing (refer to FIG. 2), the driving means 60 forms a diamond-shaped pattern 15 by driving the jetting means 20, but this is only an exemplary pattern, and it is apparent that any pattern such as a triangular pattern, an octagonal pattern, a circular pattern, etc. can be formed.

The conductive polymer solution 25 is jetted onto one surface of the transparent substrate 10 from the jetting means 20, and undergoes post-processing such as drying, and then finally becomes a transparent electrode having high electric conductivity and high visible ray transmittance. In this case, the type of conductive polymer solution 25 is not especially limited, but may include poly-3, 4-ethylenedioxythiophene/poly styrenesulfonate (PEDOT/PSS), polyaniline, polyacetylene or polyphenylene vinylene. Since the transparent conductive layer manufacturing apparatus 100 forms the transparent conductive layer using the conductive polymer solution 25, the flexibility of the transparent substrate 10 is excellent. Therefore, even if the transparent substrate 10 is bent, variation in electric conductivity is not large, so that a touch panel having excellent durability can be implemented. Further, since variation in visible ray transmittance is small according to variations in wavelength, visible ray transmittance is not deteriorated at specific wavelengths, and thus a touch panel having excellent visibility can be implemented.

Meanwhile, since the conductive polymer solution 25 contains ions, the transparent substrate 10 is not only uniformly coated with the conductive polymer solution 25, but also accurately patterned with the conductive polymer solution 25. This will be described in detail later.

The wire 30 which functions to allow the transparent substrate 10 to be uniformly coated with the conductive polymer solution 25 is spaced apart from the other surface of the transparent substrate 10 by a predetermined distance and is arranged in the Z axis direction. Here, a potential having the polarity opposite to that of the ions contained in the conductive polymer solution 25 is applied to the wire 30 by the voltage application means 40. For example, when ions contained in the conductive polymer solution 25 are positive ions, a negative potential is applied to the wire 30 by the voltage application means 40. When ions contained in the conductive polymer solution 25 are negative ions, a positive potential is applied to the wire 30 by the voltage application means 40. Therefore, an electric attractive force is generated between the wire 30 and the conductive polymer solution 25, so that the transparent substrate 10 can not only be uniformly coated with the conductive polymer solution 25 along the wire 30, but also be accurately patterned with the conductive polymer solution 25. Further, even if the size of the transparent substrate 10 is increased, the present invention can cope with the variation in size by increasing the length of the wire 30. Accordingly, there is the advantage that a transparent conductive layer required for a large area touch panel can be manufactured.

Meanwhile, the type of ions contained in the conductive polymer solution 25 is not especially limited as long as the ions can generate an electric attractive force with the wire 30. However, the ions may be preferably implemented using positive ions of alkali metals including Na⁺ or K⁺, or positive ions of alkaline earth metals including Mg²⁺ or Ca²⁺. There are the advantages that since those ions are positive ions, there is no risk of reducing the conductive polymer solution 25, and in that since those ions are water-soluble, they are uniformly distributed in the conductive polymer solution 25. In particular, Na⁺ is included in an initiator for causing the polymerization of the conductive polymer solution 25 (in the case of poly-3, 4-ethylenedioxythiophene/poly styrenesulfonate), and thus there is no need to separately add the ions to the conductive polymer solution 25.

As described above, the voltage application means 40 functions to apply a potential, having the polarity opposite to that of the ions contained in the conductive polymer solution 25, to the wire 30. In this case, the magnitude of the potential applied by the voltage application means 40 can be adjusted in consideration of the concentration of the ions contained in the conductive polymer solution 25, the viscosity of the conductive polymer solution 25, the movement speed of the transparent substrate 10, etc.

Hereinafter, a process for operating the transparent conductive layer manufacturing apparatus 100 according to an embodiment of the present invention will be briefly described.

First, as shown in FIG. 1, the transparent substrate 10 is moved to an area between the jetting means 20 and the wire 30. In this case, the transparent substrate 10 is moved in the X axis direction using the moving means 50 such as a roller. Further, the jetting means 20 is arranged over the transparent substrate 10 in the Y axis direction. The wire 30 is arranged below the transparent substrate 10 in the Z axis direction. Meanwhile, high-frequency processing or primer processing is preferably performed on the transparent substrate 10 so as to improve adhesive strength between the transparent substrate 10 and the conductive polymer solution 25 to be jetted.

Next, as shown in FIG. 2, when the transparent substrate 10 is caused to pass through the area between the jetting means 20 and the wire 30, the jetting means 20 jets the conductive polymer solution 25 onto one surface of the transparent substrate 10, and the voltage application means 40 applies a potential to the wire 30. In more detail, the jetting means 20 jets the conductive polymer solution 25 onto one surface of the transparent substrate 10 in the Y axis direction while being driven by the driving means 60 in the X axis direction or the Z axis direction, thus forming patterns. Simultaneously with this, the voltage application means 40 generates an electrical attractive force between the conductive polymer solution 25 and the wire 30 by applying the potential having the polarity opposite to that of the ions to the wire 30, thus uniformly coating the transparent substrate 10 with the conductive polymer solution 25 and accurately forming patterns with the conductive polymer solution 25.

According to the present invention, ions are added to the conductive polymer solution, and a wire to which a potential having the polarity opposite to that of the ions is applied is employed, thus obtaining the advantages that a transparent substrate can be uniformly coated with the conductive polymer solution, and patterns can be accurately formed on the transparent substrate with the conductive polymer solution.

Further, according to the present invention, there are effects in that manufacturing costs can be reduced compared to conventional sputtering, and the size of a substrate is not limited to that of the apparatus for manufacturing the transparent conductive layer, thereby enabling a large-area touch panel to be manufactured.

Furthermore, according to the present invention, a transparent substrate is coated with a conductive polymer solution which has excellent flexibility and has small variation in visible ray transmittance according to variations in wavelength, instead of the conventional ITO. Therefore, there is the advantage that even if the transparent substrate is bent, the variation in electric conductivity is not large, so that a touch panel having excellent durability can be implemented, and in that visible ray transmittance is not deteriorated at specific wavelengths, so that a touch panel having excellent visibility can be implemented.

Although the preferred embodiments of the present invention have been disclosed for illustrative purposes, those skilled in the art will appreciate that the apparatus for manufacturing a transparent conductive layer according to the present invention is not limited and various modifications, additions and substitutions are possible, without departing from the scope and spirit of the invention as disclosed in the accompanying claims.

What is claimed is:

1. An apparatus for manufacturing a transparent conductive layer, comprising:
a transparent substrate, a longitudinal direction of which is arranged in an X axis direction;
jetting means configured to jet a conductive polymer solution, containing ions, onto a first surface of the transparent substrate in a Y axis direction;
a wire spaced apart from a second surface of the transparent substrate by a predetermined distance and arranged in a Z axis direction; and
voltage application means configured to generate an electric attractive force between the wire and the conductive polymer solution by applying a potential having a polarity opposite to that of the ions to the wire.

2. The apparatus as set forth in claim 1, wherein the conductive polymer solution comprises poly-3, 4-ethylenedioxythiophene/poly styrenesulfonate (PEDOT/PSS), polyaniline, polyacetylene, or polyphenylene vinylene.

3. The apparatus as set forth in claim 1, wherein the ions are positive ions of alkali metals or positive ions of alkaline earth metals.

4. The apparatus as set forth in claim 3, wherein the positive ions of alkali metals are Na⁺ or K⁺ ions.

5. The apparatus as set forth in claim 3, wherein the positive ions of alkaline earth metals are Mg²⁺ or Ca²⁺ ions.

6. The apparatus as set forth in claim 3, wherein the voltage application means applies a negative potential to the wire.

7. The apparatus as set forth in claim 1, further comprising moving means for moving the transparent substrate in the X axis direction.

8. The apparatus as set forth in claim 1, further comprising driving means for driving the jetting means in the X axis or Z axis direction so that the jetting means jets the conductive polymer solution onto the first surface of the transparent substrate to form patterns on the transparent substrate.
